(19) United States
(12) Patent Application Publication
(10) Pub. No.: US 2018/0266382 A1
(43) Pub. Date: Sep. 20, 2018

(54) IGNITION SYSTEM AND INTERNAL COMBUSTION ENGINE

(71) Applicant: IMAGINEERING, INC., Kobe (JP)

(72) Inventors: Yuji IKEDA, Kobe (JP); Seiji KANBARA, Kobe (JP); Minoru MAKITA, Kobe (JP)

(21) Appl. No.: 15/540,764

(22) PCT Filed: Dec. 28, 2015
(86) PCT No.: PCT/JP2015/086492

§ 371 Date: Apr. 9, 2018

(30) Foreign Application Priority Data
Dec. 29, 2014 (JP) 2014-267050

(51) Int. Cl. F02P 23/04; F02P 9/00

(52) U.S. Cl. CPC F02P 23/045; H01Q 1/38; F02P 9/007

(57) ABSTRACT

An ignition system improves an air-fuel-ratio, i.e., good mileage and lean burn without changing a gasoline engine structure significantly. The ignition system comprises an electromagnetic wave generator including a first output part and a second output part configured to output an electromagnetic wave, a discharge device comprising a booster and a discharger provided at an output side of the booster, the booster having a resonance structure configured to boost an electromagnetic wave inputted from the first output part so as to cause a discharge from the discharger, and an electromagnetic wave emitter configured to emit an electromagnetic wave inputted from the second output part. The electromagnetic wave generator decreases an output power from the first output part, while the electromagnetic wave generator increases the output power from the second output part when an amount of a reflected wave from the discharge device exceeds a predetermined value.

### TECHNICAL FIELD

The present invention relates to an ignition system that is used in an internal combustion engine.

### BACKGROUND ART

Ignition plugs such as spark plugs have been used conventionally in the internal combustion engine such as gasoline engine.

In these days, electric cars in that only electricity is used as motor power and gas fuel or liquid fuel is not used, and vehicles that use fuel such as natural gas in smaller CO2 emission amount have been practically in use. However, it is difficult to advance diffusion of such vehicles smoothly since cost for vehicle main body is high expensive compared to gasoline-powered vehicles, and infrastructures such as charging station and natural gas station are still insufficient.

Accordingly, demand for gasoline-powered vehicles is still much high, and various technical developments for improving air-fuel-ratio, i.e., good mileage and lean burn in gasoline-powered vehicles are currently performed in popular.

Closely related to the above situation, the applicant suggests art of achieving air-fuel-ratio improvement by applying plasma technique to the internal combustion engine, and the development thereof has been advanced (for example, Patent Document 1).

### PRIOR ART DOCUMENT(S)

### Patent Document

Patent document 1: Japanese Patent Publication No. 4876217

Patent document 2: Japanese Patent Application No. 2013-171781

### SUMMARY OF INVENTION

### Problems to be Solved

Moreover, the applicant has developed the new-type ignition plug that causes discharge by boosting the received microwave (Patent Document 2). Since the microwave is used as power supply in this ignition plug, the discharge in high speed can continuously be performed, and non local thermodynamic equilibrium plasma can be generated in an arbitrary timing. This cannot be achieved by conventional spark plug. By use of the new-type ignition plug, the air-fuel-ratio can be improved.

However, since the above ignition plug is designed to be smaller in size than the conventional spark plug due to adoption of resonance structure of microwave, plasma-generation-possible-range is reduced. Therefore, when the ignition plug is used for larger sized engine and operation load is high and etc., there is a case where enough size of plasma cannot be generated.

The present invention is made in view of the above points.

### Measures for Carrying out the Invention

An ignition system of the present invention comprises an electromagnetic wave generator including a first output part and a second output part configured to output an electromagnetic wave, a discharge device comprising a booster and a discharger provided at an output side of the booster, the booster having a resonance structure configured to boost an electromagnetic wave inputted from the first output part so as to cause a discharge from the discharger, an electromagnetic wave emitter configured to emit an electromagnetic wave inputted from the second output part, and the electromagnetic wave generator decreases an output power from the first output part, while the electromagnetic wave generator increases the output power from the second output part when an amount of a reflected wave from the discharge device exceeds a predetermined value.

### Effect of Invention

According to an ignition system of the present invention, a discharge device that the microwave is used as a power supply is adopted, and therefore, non local thermodynamic equilibrium plasma can be generated in an arbitrary timing, and an air-fuel-ratio, i.e., good mileage and lean burn can be improved. Additionally, an electromagnetic wave emitter to assist an ignition and a combustion is used together. Therefore, enough strong plasma can be generated. Moreover, since the ignition unit of the present invention adopts a structure that a reduced-size ignition plug is incorporated with an antenna, the size thereof is a size insert-able into a cylinder head. Therefore, the ignition unit of the present invention can be utilized to the internal combustion engine such as the gasoline engine without changing engine shape or specification significantly.

### BRIEF EXPLANATION OF THE DRAWINGS

FIG. 1 illustrates a schematic block diagram of an ignition system regarding a first embodiment.

FIG. 2 illustrates a front view of a partial cross section of an ignition unit of the first embodiment.

FIG. 3 illustrates the front view of the partial cross section of a discharge device of the first embodiment.

FIG. 4 illustrates an equivalent circuit of the discharge device of the first embodiment.

FIG. 5 illustrates the front view of the partial cross section of the discharge device of the first embodiment.

FIG. 6 illustrates the front view of an antenna part of the discharge device of the first embodiment.

FIG. 7 illustrates the schematic block diagram of an electromagnetic wave generator regarding the first embodiment.

FIG. 8 illustrates the front view of the partial cross section of an ignition unit of a second embodiment.

FIG. 9 illustrates the front view of the partial cross section of an ignition unit of a third embodiment.

FIG. 10 illustrates the front view of the partial cross section of an ignition unit of a fourth embodiment.

### DESCRIPTION OF THE PREFERRED EMBODIMENTS

In below, embodiments of the present invention are illustrated in details based on figures. Note that, following embodiments are essentially desirable examples, and the scope of the present invention, the application product, or the use does not intend to be limited.

### First Embodiment

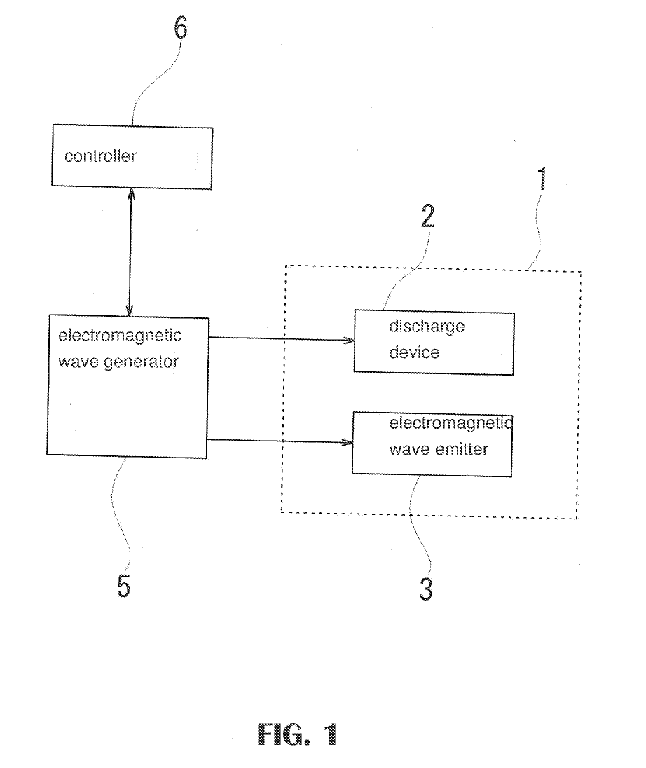

Referring to FIG. 1, an ignition system 10 of the present embodiment includes a discharge device 2, an electromagnetic wave emitter 3, an electromagnetic wave generator 5 configured to supply microwaves to these, and a controller 6 configured to control the electromagnetic wave generator 5. The discharge device 2 as described later in details is one kind of spark plug that was developed by the applicant. The electromagnetic wave emitter 3 emits microwave. In the ignition system 10, the discharge is firstly caused by the discharge device 2, and thereby, the fuel inside the combustion chamber of the internal combustion engine is ignited. Next, microwave is irradiated from the electromagnetic wave emitter 3 so as to expand the flame.

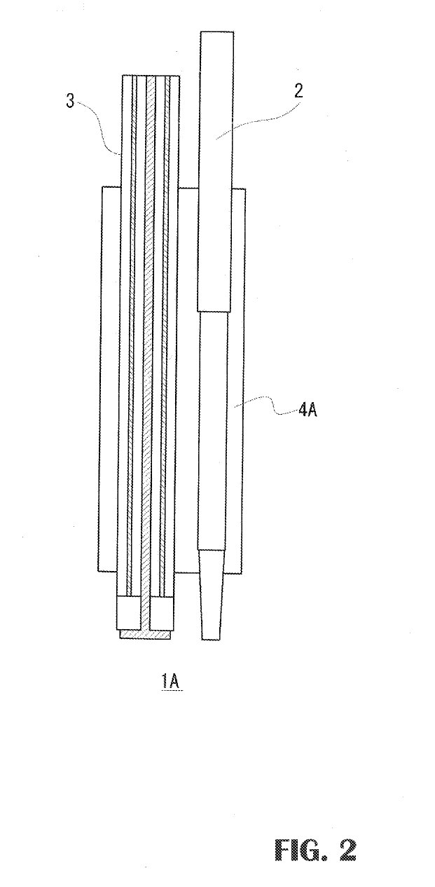

As illustrated in FIG. 2, the discharge device 2 and the electromagnetic wave emitter 3 are housed in a casing 4, and they constitute an integrally included ignition unit 1A. With regard to the ignition unit 1A, the casing 4 can entirely be inserted into a mounting port of the cylinder head. Specifically, it is assumed that the ignition unit 1A of the present embodiment replaces to the spark plug widely spreadly used in gasoline engine. Therefore, the ignition unit 1A has a size insert-able into so called M12 plug hole. That is, a diameter of the discharge device 2 is about 5 mm, and the diameter of the electromagnetic wave emitter 3 is also about 5 mm. The casing 4 includes two ports for inserting the discharge device 2 and the electromagnetic wave emitter 3 respectively into, and shapes of respective ports are designed such that tip ends of the discharge device 2 and the electromagnetic wave emitter 3 protrude into the engine combustion chamber. Moreover, if a heat release performance of the discharge device 2 and the electromagnetic wave emitter 3 is put priority onto, a metal with high thermal conductivity is preferably adopted as the material of the casing 4. On the other hand, if an insulation performance between the discharge device 2 and the electromagnetic wave emitter 3 is put priority onto, an insulator such as ceramics is preferably adopted. However, a material having high thermal resistance performance should be adopted for use, because it is used for engine.

Note that, the ignition unit 1A may be used for not only reciprocating engine but also rotary engine. When the ignition unit 1A is used for rotary engine, it is dangerous, if the tip parts of the discharge device 2 and the electromagnetic wave emitter 3 are in condition of protruding into the combustion chamber, because the rotor contacts with the tip parts. Therefore, the discharge device 2 and the electromagnetic wave emitter 3 should be constituted such that the tip parts do not protrude into the combustion chamber.

The discharge device 2 is also called as “Microwave Discharge Igniter (“MDI”: Registered Trademark).” It is constituted that 2.45 GHz band microwaves received from outside (electromagnetic wave generator 5) resonate, microwaves are boosted by resonation, the tip part (discharger) becomes high in voltage, and as a result, the discharge is caused. In this regard, the discharge device 2 largely differs from the normal spark plug.

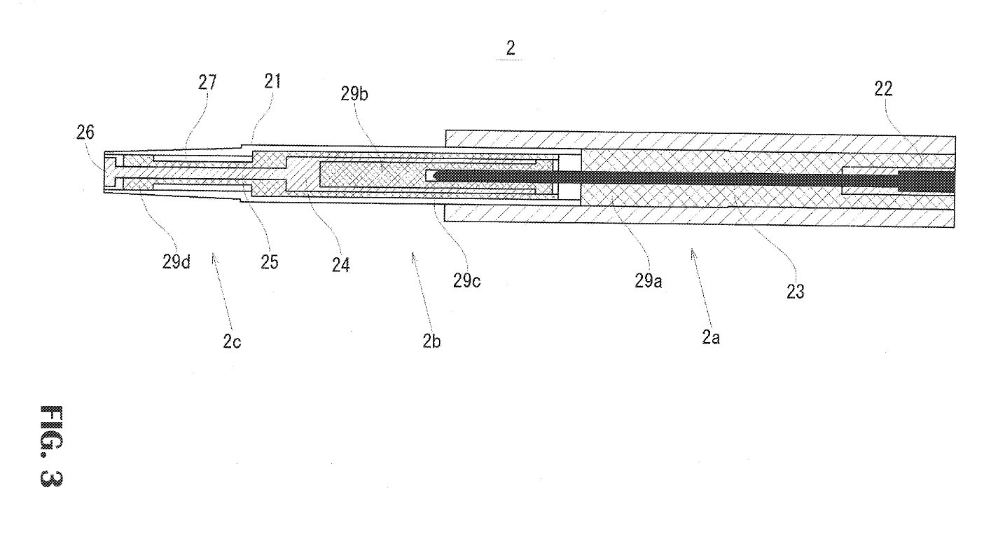

Referring to FIG. 3, the structure of the discharge device 2 is described in details. The discharge device 2 includes an input part 2a configured to input an microwave, a coupling part 2b configured to attain an impedance matching between the electromagnetic wave generator 5 designed at normally 50Ω system or a coaxial cable configured to transmit the microwave and the resonance structural part of the discharge device 2, and an amplifying part 2c configured to amplify voltage of microwave that is resonated by the microwave resonance structure. Moreover, the amplifying part 2c at the distal end thereof has a discharge electrode 26. The respective parts inside the discharge device 2 are housed by a cylindrical casing 21 that is made of metal with the electric conductivity.

The input part 2a comprises an input terminal 22 configured to receive microwave that is generated at the electromagnetic wave generator 5, and a first center electrode 23. The first center electrode 23 transmits microwave. A dielectric 29a is provided between the first center electrode 23 and the casing 21. The dielectric 29a is made of ceramic materials, for example.

The coupling part 2b includes the first center electrode 23 and a second center electrode 24. The coupling part 2b is provided to attain the impedance matching as described as above. The second center electrode 24 has a cylindrical structure that includes a bottom part at the amplifying part 2c side, and the cylindrical part surrounds the first center electrode 23. The stick-type first center electrode 23 and an inner wall of the cylindrical second center electrode 24 face from each other, and the microwave is transmitted from the first center electrode 23 to the second center electrode 24 by capacity-coupling at the facing part. In the cylindrical part of the second center electrode 24, a dielectric 29b such as ceramics is filled with, and a dielectric 29c such as ceramics is also provided between the second center electrode 24 and the casing 21.

The amplifying part 2c is provided with a third center electrode 25. The third center electrode 25 is connected to the second center electrode 24, and the microwave is transmitted from the second center electrode 24 to the third center electrode 25. A discharge electrode 26 is installed at a distal end of the third center electrode 25. Between the third center electrode 25 and the casing 21, a dielectric 29d such as ceramics is filled with. As explained below, a cavity part 27 in which the dielectric 29d is not filled with is provided between the third center electrode 25 and the casing 21 in order to adjust the discharge capacity C3. The third center electrode 25 includes a coil element, and potential in microwave becomes in higher as the microwave passes through the third center electrode 25. As the result, several tens KV of high voltage occur between the discharge electrode 26 and the casing 21, and the discharge is caused between the discharge electrode 26 and the casing 21. Moreover, the third center electrode 25 length is about ¼ wavelength of microwave. Here, the ¼ wavelength is the length that takes into consideration of, for example, refractive index of the center electrode, and the ¼ wavelength does not mean directly or simply the ¼ wavelength exactly as stated. Based on the length, if adjustment or design is performed such that a node of microwave is positioned at a boundary between the third center electrode 25 and the second center electrode 24 as an example, an anti-node of microwave becomes positioned at the distal end of the third center electrode 25 at which the discharge electrode 26 exists. Therefore, the voltage at the point can make larger and higher. Of course, such design is not always preferable for various factors. However, the design is performed based on such concept in the present embodiment.

An annular circular space is formed between the discharge electrode 26 and the casing 27, and discharge is caused in this space. That is, the discharge is performed in any direction. This point differs from the spark plug that performs so called “discharge at one point” between the discharge electrode and the ground electrode.

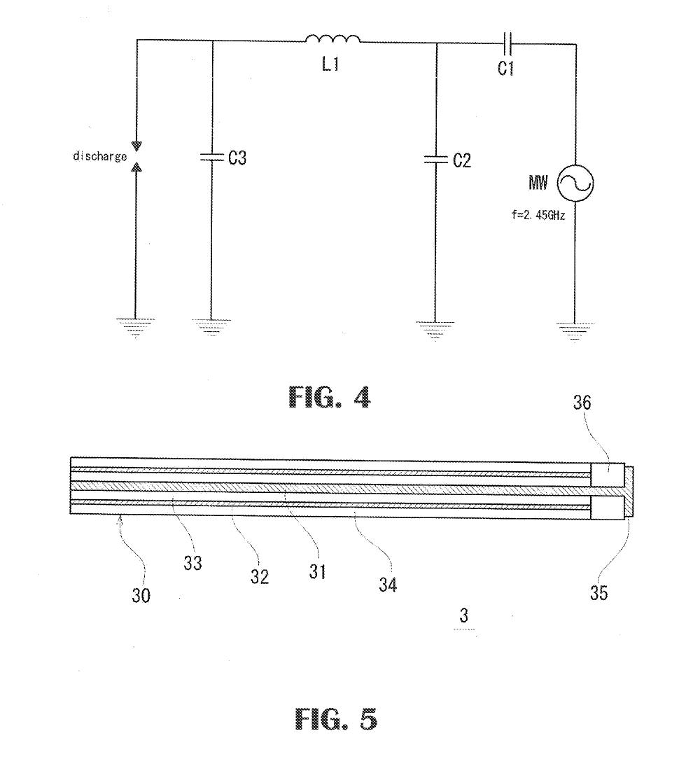

FIG. 4 is a figure illustrating an equivalent circuit of the discharge device 2. The microwave received from an outside oscillation circuit (MW) having voltage V1, frequency 2.45 GHz, is connected to the resonance circuit that is constituted of capacity C3, reactance L, and capacity C2 via capacity C1. Moreover, the discharger is provided in parallel with the capacity C3.

Here, C1 corresponds to a coupling capacity, and C1 is determined mainly by positional relation between the second center electrode 24 and the first center electrode 23 (distance between both the electrodes and area of mutually facing part) and material filled with between both the electrodes, in the present example, ceramic structural dielectric 29b. The first center electrode 23 may be constituted movably in the center axis direction so as to attain easily impedance adjustment.

The capacity C2 is a grounding capacity that is formed by the second center electrode 24 and the casing 21. C2 is determined by the distance from the second center electrode 24 to the casing 21, the mutually facing area, and the relative permittivity of the dielectric 29c. The casing 21 is formed of metal with electric conductivity and functions as the ground electrode. Reactance L corresponds to a coil element of the third center electrode 25.

The capacity C3 is a discharge capacity that is formed by the third center electrode 25, the discharge electrode 26, and the casing 21. This is determined by such as (1) shape of the discharge electrode 26, size thereof, and distance to/from the casing 21, (2) distance from the third center electrode 25 to the casing 21, and (3) cavity space (air layer) 27 that is provided between the third center electrode 25 and the casing 21, and thickness of the dielectric 29d. If C2>>C3, the potential difference between both the ends of the capacity C3 can sufficiently become larger than V1. As the result, the discharge electrode 26 can make potential in high. Moreover, since C3 can make smaller, the condenser area can be reduced. Note that, the capacity C3 is substantially defined by the mutually facing part of the third center electrode 25 and the casing 21 that sandwitchs the dielectric 29d. To put it the other way around, the cavity space (air layer) 27 is changed of length in the axial direction, and thereby, the capacity C3 can also be adjusted.

In a case where the coupling capacity C1 is deemed to be sufficiently small, the capacity C3, reactance L, and the capacity C2, constitute a series resonance circuit, and the resonance frequency f is expressed in below mathematical formula 1.

$$\begin{matrix}f = \frac{1}{2 π \sqrt{LC}} & ( formula 1 ) \\ where \frac{1}{C} = \frac{1}{{C}_{2}} + \frac{1}{{C}_{3}} & \end{matrix}$$

That is, the discharge device 2 is designed such that the discharge capacity C3, the coil reactance L, and the grounding capacity C2 satisfy the relation of the mathematical formula 1, if f=2.45 GHz.

As described above, the discharge device 2, by boosting system of the resonator, generates voltage Vc3 higher than power supply voltage, i.e. voltage V1 of microwave inputted into the discharge device 2. Thereby, discharge is caused between the discharge electrode 26 and the ground electrode (casing 21). When the discharge voltage exceeds the breakdown voltage of gas molecules existed in the vicinity thereof, electrons are released from the gas molecules, and non local thermodynamic equilibrium plasma is generated to eventually ignite fuel.

Furthermore, since the 2.45 GHz band frequency is used, the condenser capacity can be made smaller, and the use of the discharge device 2 is advantageous in size reduction. Since the discharge device 2 is made in reduced size, the size thereof can become similar with the conventional spark plug if the discharge device 2 is combined with the electromagnetic wave emitter 3 described in below. Moreover, as the result of adopting the boosting system, the vicinity of the discharge electrode 26 of entire the discharge device 2 only becomes potential in high. Therefore, a great advantage in isolation is being made.

Additionally, the discharge device 2 is driven by microwave, and therefore, the discharge device 2 can freely be controlled intermittently through controlling the electromagnetic wave generator 5 by the controller 6 (referring to FIG. 1). That is, the control of the timing of microwave generation by the electromagnetic wave generator 5 leads to freely control of the discharge timing of the discharge device 2. In the normal spark plug that uses ignition coil with large reactance, it is difficult to respond high in speed and it is difficult to perform discharge continuously. On the other hand, since the discharge device 2 is driven by microwave, it can respond high in speed. By controlling the electromagnetic wave generator 5 freely, discharge in almost continuous of the high frequency can be generated in an arbitrary timing. Accordingly, various control can be performed.

As above, the discharge device 2 of the present embodiment largely differs from the conventional spark plug.

Next, referring to FIG. 5, the electromagnetic wave emitter 3 is largely divided into an antenna part 35 configured to emit the microwave into the combustion chamber and a transmission line 30 configured to transmit the microwave from the electromagnetic wave generator 5 to the antenna part 35.

Moreover, the electromagnetic wave emitter 3 includes a power supply unit (not illustrated in FIG. 5) configured to supply microwave from the transmission line 30 to the antenna part 35. The transmission line 30 can also be configured to be attachable and detachable with regard to the power supply unit. Note that, the transmission line 30 is constituted as a coaxial structure, and the transmission line 30 includes a center conductor 31 configured to transmit the microwave. Further, the transmission line 30 is provided with an outer conductor 32 configured to function as a ground and to prevent the microwave from leaking to outside. An insulator such as ceramics is filled with between the center conductor 31 and the outer conductor 32. For example, an insulator made of elastic member covers the outside of the outer conductor 32.

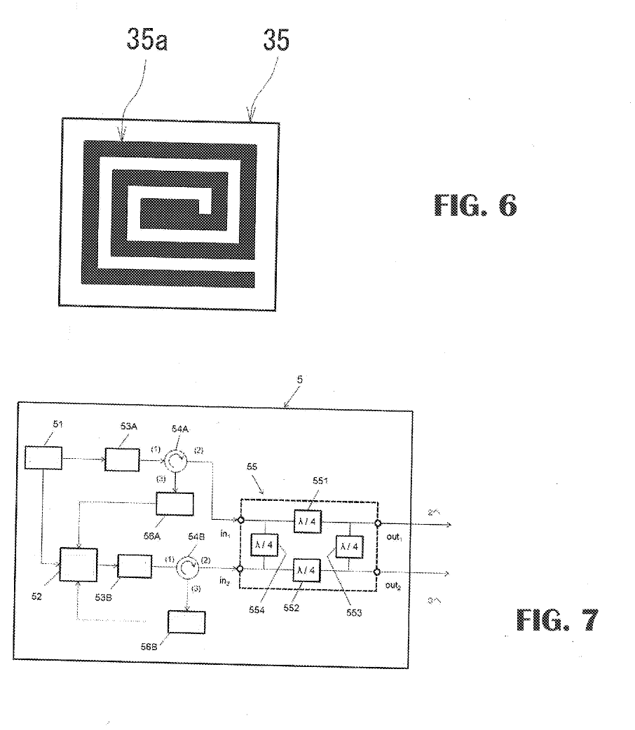

As illustrated in FIG. 6 for example, the antenna part 35 can be formed by, for example, printing a metal pattern 35a in a spiral manner on a ceramic substrate.

The electromagnetic wave emitter 3 of the present embodiment is merely one example. If the electromagnetic wave emitter 3 is configured to emit the microwave into the combustion chamber, it is not limited to the above embodiment version.

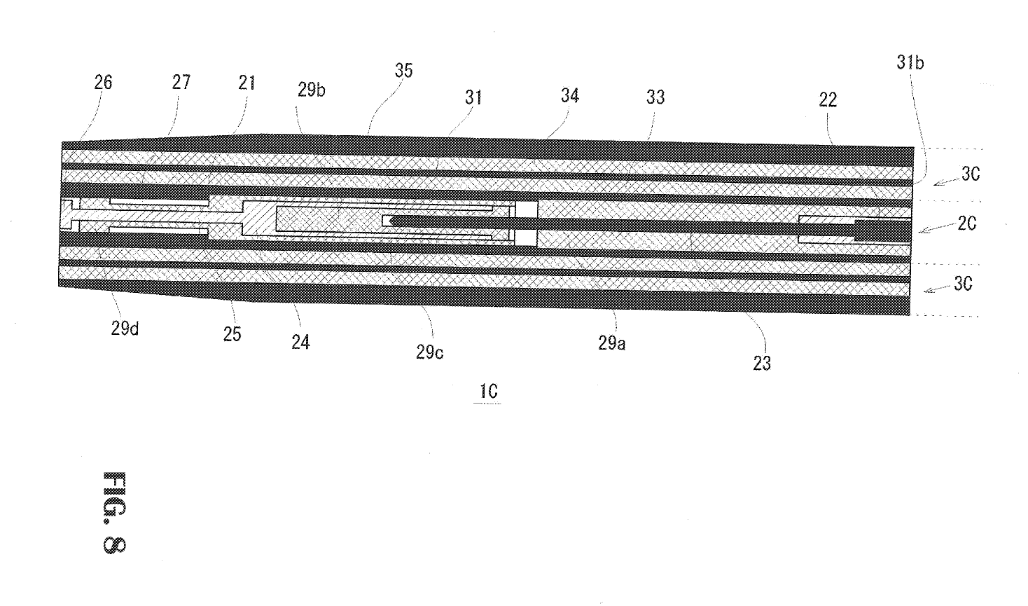

Referring to FIG. 7, a configuration of the electromagnetic wave generator 5 is explained. The electromagnetic wave generator 5 comprises an oscillator (electromagnetic wave oscillator) 51, a variable phase shifter 52, amplifiers 53A, 53B, circulators 54A, 54B, a coupler 55, and a detector 56.

The oscillator 51 is configured to oscillate a microwave at 2.45 GHz. The oscillator 51 outputs an oscillation microwave to the amplifier 53A and the variable phase shifter 52.

The variable phase shifter 52 changes a phase of microwave outputted from the oscillator 51. The change is made based on instructions from the controller 6 or output from the detector 56. The detail is described later.

The amplifier 53A amplifies microwave outputted from the oscillator 51. The amplifier 53B amplifies microwave outputted from the variable phase shifter 52. As an example, the microwave having the amplitude 32[V] is amplified up to about 1[kW] so as to output.

The circulator 54A is interposed between the amplifier 53A and an input terminal in₁ of the coupler 55. The circulator 54B is interposed between the amplifier 53B and an input terminal in₂ of the coupler 55. The circulators 54A, 54B are three-port-circulators. The microwave inputted from the terminal (1) of the figure is outputted from the terminal (2), and the microwave inputted from the terminal (2) is outputted from the terminal (3). Accordingly, microwaves inputted from each amplifier 53 to each terminal (1) of respective circulators 54 are outputted respectively from each terminal (2) to the coupler 55.

On the other hand, as described in below, reflected waves from the discharge device 2 and the electromagnetic wave emitter 3 may return back to the coupler 55, and then the returning of reflected waves into the amplifier 53 may be caused. At the circulator 54, the reflected wave inputted from the coupler 55 to the terminal (2) is outputted to the terminal (3), and the reflected wave is not outputted to the terminal (1) connected to the amplifier 53. Therefore, the returning of the reflected wave to the amplifier 53 can be prevented, and the circuit of the amplifier 53 can be protected.

Moreover, by providing the current detector 56 at the output side of terminal (3), the magnitude of the reflected wave from the discharge device 2 and the electromagnetic wave emitter 3 can be detected. As described below, when the discharge device 2 is in condition of discharge, the amount of the reflected wave circulating return to the coupler 55 is increased. Accordingly, if the current value of the detector 56 is detected when the discharge device 2 is “on”, i.e., the microwave is supplied to the discharge device 2, the condition of discharge by the discharge device 2 can be estimated.

As described above, the ignition system 10 firstly makes the discharge device 2 discharge so as to ignite fuel in the combustion chamber, and then, makes the electromagnetic wave emitter 3 emit microwave so as to expand the flame. Regarding the ignition system 10 of the present embodiment, in a case where the current value of the detector 56 is increased, it is estimated that the discharge device 2 is in condition of discharge, and then, the microwave is emitted from the electromagnetic wave emitter 3 by changing phase lagged amount and phase advancing amount of the variable phase shifter 52. The above processing is described also in below.

When the microwave is emitted from the electromagnetic wave emitter 3 and the plasma is generated inside the combustion chamber, since the microwave is absorbed by plasma, the amount of reflected wave returning back to the coupler 55 is small. On the other hand, when the plasma is not generated in the combustion chamber, the microwave is not absorbed by plasma, and the amount of reflected wave returning back to the coupler 55 is increased. Accordingly, if the current value of the detector 56 is detected when the electromagnetic wave emitter 3 is “on”, i.e., the microwave is supplied to the electromagnetic wave emitter 3, the plasma generation condition inside the combustion chamber can also be estimated.

In the present embodiment, the coupler 55 is constituted of a branch line coupler. The coupler 55 includes two input terminals in₁ and in₂, and two output terminals out₁ and out₂. Further, the coupler 55 comprises phase shifters 551, 552, 553, and 554 configured to delay the microwave phase by ¼ wavelength, i.e., 90°. The phase shifter 551 is connected between the input terminal in₁ and the output terminal out₁. The phase shifter 552 is connected between the input terminal in₂ and the output terminal out₂. The phase shifter 553 is connected between the output terminal out₁ and the output terminal out₂. The phase shifter 554 is connected between the input terminal in₁ and the input terminal in₂.

The coupler 55 is designed such that a signal inputted from the input terminal side belonging to the microwave frequency band region is isolated between the input terminal in₁ and the input terminal in₂. That is, the microwave entered from the input terminal in₁ hardly appears at the input terminal in₂. Similarly, the microwave entered from the input terminal in₂ hardly appears at the input terminal

On the other hand, the coupler 55 is designed such that the signal inputted from the input terminal in₁ belonging to the microwave frequency band region is outputted from the output terminals out₁, out₂ in an equal magnitude, i.e., distributed equally to be outputted. It is also designed such that the signal inputted from the input terminal in₂ belonging to the microwave frequency band region is outputted from the output terminals out₁, out₂ in an equal magnitude.

Next, switching process of the discharge device 2 and the electromagnetic wave emitter 3 by the electromagnetic wave generator 5 is explained.

Supposing the microwave generated by oscillation at the oscillator 51 is “sin ωt”, the variable phase shifter 52 lags the microwave in phase by θ°, and amplification factors at the amplifier 53A and 54B are respectively A and B, the microwave amplitude Mᵢ₁ and Mᵢ₂ inputted into input terminals in₁ and in₂ of the coupler 55 is respectively expressed as the mathematical formula 2.

Mᵢ₁=A sin ωt

Mᵢ₂=B sin(ωt−θ) (formula 2)

The amplitude of microwave Mₒ₁, Mₒ₂ inputted to the output terminals out₁ and out₂ of the coupler 55 is expressed as the formula 3.

$$\begin{matrix}{M}_{01} = A sin ( ω t - \frac{π}{2} ) + B sin ( ω t - θ - π ) \\ = - A cos ω t - B sin ( ω t - θ )\end{matrix} \\ \begin{matrix}{M}_{02} = A sin ( ω t - π ) + B sin ( ω t - θ - \frac{π}{2} ) \\ = - A sin ω t - B cos ( ω t - θ )\end{matrix} \qquad ( formula 3 )$$

That is, a synthetic wave of a wave lagged in phase by the phase shifter 551 by 90° with respect to microwave inputted from the input terminal in ₁ and a wave lagged in phase by phase shifters 552 and 553 by 180° with respect to microwave inputted from the input terminal in₂, is outputted from the output terminal out₁. Similarly, the synthetic wave of a wave lagged in phase by phase shifters 551 and 553 by 180° with respect to microwave inputted from the input terminal in₁ and a wave lagged in phase by the phase shifter 552 by 90° with respect to microwave inputted from the input terminal in₂, is outputted from the output terminal out₂. As described above, the coupler 55 is designed such that the microwave is isolated between the input terminal in₁ and the input terminal in₂. Therefore, microwave passing through the phase shifter 554 is ignored in the formula 3.

Now, supposing A=B, and the variable phase shifter 52 lags microwave in phase by 90°, “θ=90° ” is substituted into the formula 3, and the formula 4 is obtained.

Mₒ₁=−Acos ωt+Acos ωt=0

Mₒ₂=−Asin ωt−Asin ωt=2Asin ωt (formula 4)

That is, in a case where the variable phase shifter 52 lags the microwave in phase by 90°, microwave is not outputted from the output terminal out₁, while the microwave having amplitude twice that of microwave outputted from amplifiers 53A and 53B respectively is outputted from the output terminal out₂. In other word, the microwave is not supplied into the discharge device 2, and only supplied to the electromagnetic wave emitter 3.

On the other hand, in a case where the variable phase shifter 52 advances the microwave in phase by 90°, “θ=−90° ” is substituted into the formula 3, and the formula 5 is obtained.

Mₒ₁=−Acos ωt−Acos ωt=−2Acosωt

Mₒ₂=−Asin ωt+Asin ωt=0 (formula 5)

That is, if the variable phase shifter 52 advances the microwave in phase by 90°, the microwave having amplitude twice that of microwave outputted from amplifiers 53A and 53B respectively is outputted from the output terminal out₁, while the microwave is not outputted from the output terminal out₂. In other word, the microwave is only supplied to the discharge device 2 and not supplied to the electromagnetic wave emitter 3.

As such, the difference in phase of microwave inputted into two input terminals of the coupler 55 is controlled by the variable phase shifter 52, and thereby, the microwave supply destination can be switched between the discharge device 2 and the electromagnetic wave emitter 3.

The microwave supplied to the discharge device 2 from the output terminal out₁ is boosted by the microwave resonance structure inside the discharge device 2. As a result, the potential at the discharge electrode 26 becomes higher and enhanced, and the discharge is caused at the distal end of the discharge device 2 (between the discharge electrode 26 and the ground electrode). When the discharge is caused, an impedance between the discharge electrode 26 and the ground electrode is changed, and therefore, the impedance of the discharge device 2 itself is also changed to eventually become an impedance deviated from the microwave resonance condition, and the microwave inputted into the discharge device 2 is partially reflected and again returned to the coupler 55 of the electromagnetic wave generator 5. Almost half of microwaves reversed in flow from the output terminal out₁ of the coupler 55 routes through the phase shifter 551, and then routes through the circulator 54A from the input terminal in₁ to enter into the detector 56A. The other half routes through the phase shifters 551 and 554, and then routes through the circulator 54B from the input terminal in₂ to enter into the detector 56B. When the amplitude of microwave inputted into respective detectors 56 is increased, it is assumed that the discharge is caused at the discharge device 2, and the variable phase shifter 52 changes microwave phase advance angle or delay angle. In this example, 90° advance angle of the microwave is changed into 90° delay angle.

The detector 56 may be provided to any one of circulators 54A and 54B. However, if the detector 56 is provided to both the circulators 54 as above, the reflected wave can accurately be detected even if something is wrong with one of detectors 56. The coupler 55 of the present embodiment is designed such that the signal inputted from the output terminal side belonging to the microwave frequency band region is isolated between the output terminal out₁ and the output terminal out₂, and the microwave entered from the output terminals out₁ and out₂ respectively, hardly appears at the other output terminal.

As above, the electromagnetic wave generator 5 firstly supplies the microwave only to the discharge device 2. The fuel in the combustion chamber is ignited by discharge of the discharge device 2, next the switching of microwave supply destination to the electromagnetic wave emitter 3 side is performed by the electromagnetic wave generator 5 so as to expand flame, and the microwave is emitted from the electromagnetic wave emitter 3. Thereby, in the ignition system 10, the use of the microwave resonance structure in the discharge device 2 leads to the air-fuel-ratio-improvement-effect, and plasma size required when used for large sized engine or operation load is larger, can be obtained.

Moreover, the use/nonuse of the electromagnetic wave emitter 3 may be switched according to an operation condition. For example, during a first operation condition at a low load is detected, the ignition is performed by only the discharge of the discharge device 2, and during a second operation condition at a high load is detected, the ignition is performed by the discharge device 2, and then, the flame can also be expanded by using the electromagnetic wave emitter 3.

As above, the delay angle in phase is switched at plus or minus 90° by the variable phase shifter 52. By switching the delay angle between minus 90° and plus 90° optionally, the ratio of microwave supplied to the discharge device 2 and the ratio of microwave supplied to the electromagnetic wave emitter 3 can be changed. This is clear based on the above formulas.

Furthermore, as above explained, the coupler 55 is designed such that the signal inputted from the output terminals out₁, out₂ belonging to the microwave frequency band region is isolated. However, if the coupler configured not to be isolated is used, the microwave inputted from the output terminal out₁ passes through the phase shifter 553. As the result, the microwave delayed in phase at 90° by the phase shifter 551 and the microwave delayed in phase at 270° by phase shifters 553, 552, and 554, are cancelled from each other at the input terminal in₁. That is, since the microwaves in opposite phase relation are cancelled from each other, microwave inputted from the output terminal out₁ hardly appears at the input terminal in₁, or, only the small signal appears. On the other hand, the microwave delayed in phase at 180° by phase shifters 551, 554 and the microwave delayed in phase at 180° by phase shifters 553, 552 are synthesized at the input terminal in₂. In other word, microwaves in homeomorphic phase relation are synthesized. Supposing no loss inside the coupler 55 is assumed, the microwave having amplitude similar with that of the microwave inputted from the output terminal out₁ is outputted from the input terminal in₂. Accordingly, in this case, the detector 56 may be provided only at the terminal (3) side of the circulator 54B so as to detect the reflected wave from the discharge device 2.

### Second Embodiment

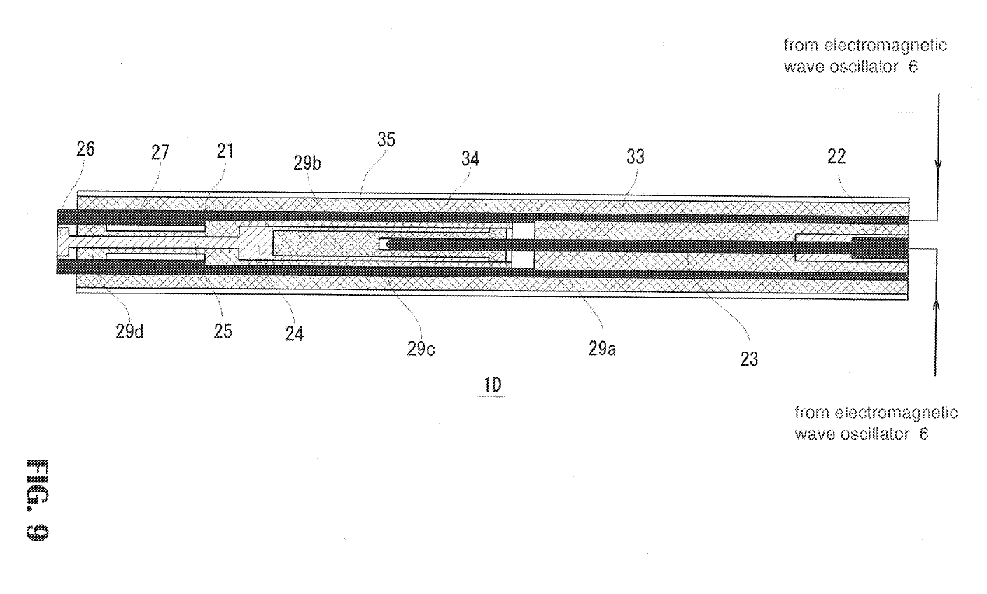

In the first embodiment, the discharge device 2 and the electromagnetic wave emitter 3 are constituted separately. On the other hand, in the ignition unit 1C of the present embodiment, the discharge device 2 is together integrated with the electromagnetic wave emitter 3 as described in FIG. 8. In the ignition unit 1C, the electromagnetic wave emitter 3C is formed on the outer circumference of the discharge device 2.

Here, the structure of the discharge device 2C differs from the discharge device 2 of the first embodiment in shape of the casing. However, the structures other than the above are similar with the first embodiment.

On the other hand, the electromagnetic wave emitter 3C comprises an insulating tube 33, an induction tube 31, an insulating tube 34, and a conductive tube 35. The insulating tube 33 encompasses the outer circumference of the conductor, casing 21, and made of ceramics based on alumina, AL₂O₃ with high insulation performance and high thermal resistance performance. The induction tube 31 is provided so as to encompass the insulating tube 33. The induction tube 31 transmits toward a front end part 31a, microwave inputted from the rear end part 31b that is started from the electromagnetic wave generator 5, then reached to a rear end part 31b, and the transmitted microwave is emitted from the front end part 31a toward the combustion chamber. The induction tube 31 is made of conductor such as metal. However, the vicinity of the front end part 31a may be made of material such as alumina with high insulation performance and high thermal resistance performance. The insulating tube 34 is provided so as to encompass the circumference of the induction tube 31, and as well as the insulating tube 33, made of material with high insulation performance and high thermal resistance performance. Moreover, the conductive tube 35 is provided in the vicinity of the insulating tube 34. The conductive tube 35 is provided so as to prevent microwave propagating on the induction tube 31 from leaking to outside of the electromagnetic wave emitter 3C, and to secure the safety and the transmission efficiency.

According to the ignition unit 1C, the discharge device 2 and the electromagnetic wave emitter 3 are together integrated in a coaxial manner. Therefore, more size reduction can be realized. The applicant succeeded in a trial manufacturing of the discharge device 2 with 5 mm in diameter as an example. Therefore, the diameter of the ignition unit 1C that is constituted such that the cylindrical electromagnetic wave emitter 3C is mounted on the outer circumference of the discharge device 2, can sufficiently make around 10 mm. Accordingly, the ignition unit 1C can be inserted into the mounting port of the spark plug of, for example, gasoline engine without any change. The ignition unit 1C can be used without changing engine shape or specification significantly.

### Third Embodiment

As illustrated in FIG. 9, in the ignition unit 1D regarding the present embodiment, the discharge device 2 and the electromagnetic wave emitter 3 are together integrated as well as the second embodiment. However, in the ignition unit 1D, the point that the microwave propagates on the surface of the outer circumference of the casing 21 of the discharge device 2, i.e., the insulating tube 33 side, is different from the second embodiment. In other word, the casing 21 also functions as the insulating tube 33 of the second embodiment. Moreover, it is constituted that the outer circumference side of the tip end part of the insulating tube 31 is not encompassed by the insulating tube 34 and the conductive tube 35 so as to emit the microwave efficiently from the tip end part of the induction tube 31.

According to the above structure, the diameter size reduction of the ignition unit can be achieved, compared to the second embodiment.

### Fourth Embodiment

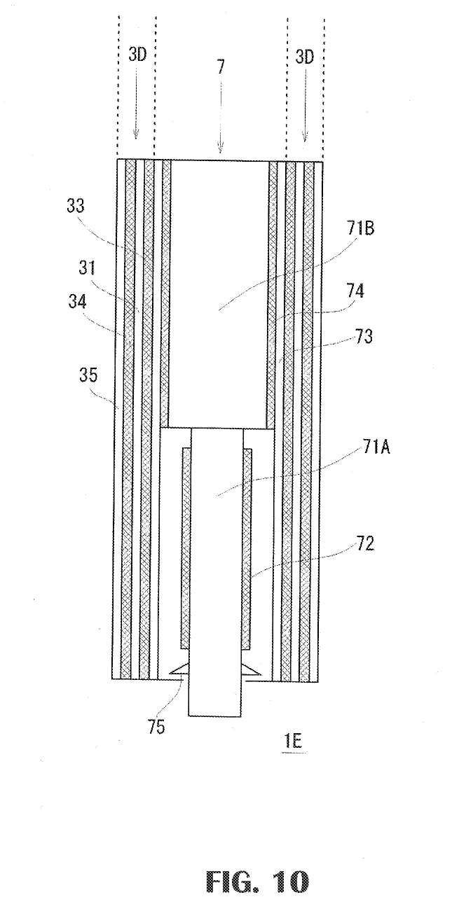

As illustrated in FIG. 10, also in the ignition unit 1E regarding the present embodiment, the discharge device and the electromagnetic wave emitter are together integrated as well as the third embodiment. However, the structure of the discharge device differs from the other embodiments.

A discharge device 7 of the present embodiment comprises components such as a center electrode 71, a dielectric 72, a ground electrode 73, and a discharge electrode 75. The center electrode 71 is divided into a first part 71A positioned at the distal end and a second part 71B positioned at rear position thereof The center electrode 71 is made of conductor such as metal, and the electromagnetic wave propagates on the surface thereof. The dielectric 72 made of ceramics based on alumina (AL₂O₃) and etc., is formed on the surface of the first part 71A. A projected discharge electrode 75 is formed at the distal end of the first part 71A. The cylindrical ground electrode 73 is provided with a space around the first part 71A and the dielectric 72.

The discharge device 7 includes a resonance structure such that the center electrode 71, the dielectric 72, and the ground electrode 73 resonate at a microwave frequency. Thereby, the boosting by the resonance structure leads to make the entered microwave voltage highest at the vicinity of the discharge electrode 75. As a result, discharge can be caused between the discharge electrode 75 and the ground electrode 73. Thereby, non local thermodynamic equilibrium plasma can be generated at the tip part of the discharge device as well as the discharge device 2 of the ignition unit 1A of the first embodiment, and fuel can be ignited.

Further, as well as the first embodiment, since the discharge device 7 is driven by the microwave, the discharge in high speed can continuously be performed in an arbitrary timing, and plasma can be generated in an arbitrary size.

The electromagnetic wave emitter 3D configured to emit the microwave is formed at a periphery of the discharge device 7. The structure of the electromagnetic wave emitter 3D is similar with the electromagnetic wave emitter 3C of the second embodiment.

Therefore, firstly after the fuel is ignited by the discharge device 7, the microwave is emitted from the electromagnetic wave emitter 3 in the case of the ignition unit 1E. Thereby, the flame ignited can be expanded also with the ignition unit 1E.

Moreover, the ignition unit 1E can also be designed in diameter about 10 mm as well as the ignition unit 1C of the second embodiment, and therefore, it can be inserted into the mounting port of the spark plug of, for example, the gasoline engine without any change.

As above, the embodiments of the present invention are explained. The scope of the present invention is absolutely defined based on inventions described in the claims, and should not be limited to the above embodiments.

For example, the discharge device 2 is not limited to the above. Other types such as a corona discharge plug manufactured by Borg Warner, “EcoFlash”(US registered trademark) may be used. However, an igniter that can continuously discharge at a high frequency is preferable for use so as to obtain the effect described as above embodiments.

Moreover, the discharge device 2 is operated by microwave, and the electromagnetic wave emitter 3 emits microwave, but the operation or emission may be performed by the electromagnetic wave belonging to other band region.

Furthermore, the discharge device 2 and the electromagnetic wave emitter 3 are together integrated by the casing 4, but they may be provided separately. For example, the discharge device 2 and the electromagnetic wave emitter 3 may respectively be provided into holes of the cylinder head separately. One of the discharge device 2 and the electromagnetic wave emitter 3 may be provided in the cylinder block or the intake-exhaust port.

In a case where the voltage inputted from the electromagnetic wave generator 5 is low, voltage at the discharge electrode 26 of the discharge device 2 does not become in high sufficiently, and as the result, there is a case where discharge between the discharge electrode 26 and the casing 21 may not be caused. At that time, the discharge electrode 26 may emit the microwave. By considering this situation the other or contrary way, the electromagnetic wave emitter 3 can be omitted. Specifically, firstly, the output voltage of the electromagnetic wave generator 5 is prepared to set high such that the discharge device 2 surely performs to discharge. Then, after the fuel is ignited, the output voltage of the electromagnetic wave generator 5 is dare to be lower, it is controlled such that the microwave is emitted from the distal end of the discharge electrode 26, and thereby, the flame can be expanded. Accordingly, the electromagnetic wave emitter 3 itself can be omitted.

It is explained in above that, in the electromagnetic wave generator 5 illustrated in FIG. 7, the oscillator 51 itself includes two electromagnetic wave output parts. However, a distributor may be connected to the output part of the oscillator 51, and the microwave may be supplied to the amplifier 53A and the variable phase shifter 52 from the distributor. Also in the structure, it corresponds to “the electromagnetic wave generator configured to output a first electromagnetic wave and a second electromagnetic wave” of the present invention.

Moreover, in the electromagnetic wave generator 5 as illustrated in FIG. 7, the variable phase shifter 52 is provided only at one output part side of the oscillator 51. However, the variable phase shifter 52 may be provided at both the output parts.

As above, the ignition system 10 is explained as applicable to gasoline engine, but the ignition system 10 can also be applicable to variable types of engines such as not only diesel engine, engine of which fuel is natural gas, or reciprocating engine, but also rotary engine, gas engine and gas turbine.

### EXPLANATION OF REFERENCES

1. Ignition Unit
2. Discharge Device
3. Electromagnetic Wave Emitter
4. Casing
5. Electromagnetic Wave Generator
6. Controller
10. Ignition System
FIG. 1
6: CONTROLLER
5: ELECTROMAGNETIC WAVE GENERATOR
2: DISCHARGE DEVICE
3: ELECTROMAGNETIC WAVE EMITTER
FIG. 7
51: OSCILLATOR
52: VARIABLE PHASE SHIFTER
53A,B: AMPLIFIER
56A, 56B: DETECTOR
TO DISCHARGE DEVICE 2
TO ELECTROMAGNETIC WAVE EMITTER 3
FIG. 9
FROM ELECTROMAGNETIC WAVE OSCILLATOR 6
FROM ELECTROMAGNETIC WAVE OSCILLATOR 6

1. An ignition system comprising:
an electromagnetic wave generator including a first output part and a second output part configured to output an electromagnetic wave;
a discharge device comprising a booster and a discharger provided at an output side of the booster, the booster having a resonance structure configured to boost an electromagnetic wave inputted from the first output part so as to cause a discharge from the discharger; and
an electromagnetic wave emitter configured to emit an electromagnetic wave inputted from the second output part,
wherein the electromagnetic wave generator decreases an output power from the first output part, while the electromagnetic wave generator increases the output power from the second output part when an amount of a reflected wave from the discharge device exceeds a predetermined value.

2. The ignition system according to claim 1,
wherein the electromagnetic wave generator comprises an electromagnetic wave oscillator configured to output a first electromagnetic wave and a second electromagnetic wave,
a coupler configured to output from the first output part a synthetic wave comprising a first component formed by phase shifting the first electromagnetic wave by quarter wavelength and and a second component formed by phase shifting the second electromagnetic wave by half wavelength, and to output from the second output part a synthetic wave comprising a first component formed by phase shifting the first electromagnetic wave by half wavelength and and a second component formed by phase shifting the second electromagnetic wave by quarter wavelength,
a variable phase shifter provided between the electromagnetic wave oscillator and the coupler and configured to change a difference in phase between the first electromagnetic wave and the second electromagnetic wave, and
a reflected wave detector configured to detect a change of a reflected wave from the discharge device, and
wherein the variable phase shifter is controlled according to the change of the reflected wave that is detected at the reflected wave detector.

3. The ignition system according to claim 2,
wherein a switching of either one of a lag in phase of the first electromagnetic wave by 180° and an advance in phase by 180° with respect to the second electromagnetic wave is performed according to the change of the reflected wave that is detected at the reflected wave detector.

4. (canceled)
